(19) United States
(12) Patent Application Publication
(10) Pub. No.: US 2007/0217141 A1
(43) Pub. Date: Sep. 20, 2007

(54) Modular, scalable storage controller midplane connector

(76) Inventors: Mohamad El-Batal, Westminster, CO (US); Greg Shogan, Round Rock, TX (US); Jason Stuhlsatz, Wichita, KS (US)

Correspondence Address: Pete Scott, Senior Corporate Counsel;LSI Logic Corporation, Legal Department - IP, 1621 Barber Lane, MS D-106, Milpitas, CA, 95035, US

(21) Appl. No.: 11/377,472

(22) Filed: Mar. 16, 2006

(51) Int. Cl. G06F 1/16

(52) U.S. Cl. 361/685

(57) ABSTRACT

A universal controller connector is modular, scalable and enables ease of connection between various storage devices (e.g., hard drives) and the same midplane controller. The universal controller connector solves the need for modularity and scalability for use with new storage controllers requiring midplane connections by managing connections between midplane controller and interface modules. The connection form factor enables universal connectivity of modules to a controller.

### TECHNICAL FIELD

The present invention is related to storage device controller connectors. More particularly, the present invention is related to a scalable interconnect for use with storage controllers. The present invention is also related to a midplane connector that is caused to become modular and scalable given its adaptation by a universal controller connector to universally accept various storage modules for connection to an interface module and various connecting hosts.

### BACKGROUND OF THE INVENTION

It has been generally known in the computing storage arts that a storage device utilizes electronic signals to exchange information between the storage device and an external device controlling the storage device. Examples of such a storage device may include magnetic or optical disk drives, magnetic or optical tape drives, and other semiconductor-based, volatile, and nonvolatile memory components (such as flash memory devices or so-called “RAM-disks”). Examples of an external device for controlling a storage device may include a host computing system, a host adapter within such a host system, a storage subsystem, a storage controller within such a storage subsystem, or any other controlling device coupled to a storage device.

Typically, signals exchanged through cables between controllers and storage devices include power signals to provide electrical power for operating the storage device and information signals (command, status and data signals) used for controlling operation of the storage device and for exchanging data to be stored in and read from the storage device. Typically, an electrical power wiring harness provides a hard-wired connection to apply power signals from an external source or device to the storage device for purposes of supplying power to the storage device. Most frequently, the electrical power signals so applied are direct current (“DC”) electrical power signals including one or more DC voltage levels used for operating the storage device. In addition, a second signal cable is typically used for exchanging information signals between an external device and the storage device. This second interface cable may utilize any of several well-known interface signal media and protocol standards including, for example, IDE, SCSI, Fibre Channel, serial attached SCSI (“SAS”) and serial AT attachment (“SATA”) signaling standards. Those of ordinary skill in the art will recognize a wide variety of other well known signaling media and protocols used for exchanging information signals and power signals between storage devices and external devices used to control the storage device. In particular, some signaling cables and signal paths provide both power and information signals over a common cabling/signal harness. It is not necessary that power and information signals be segregated between two (or more) distinct cable structures.

More recently, in more robust and manufacturable designs, hard-wire power and information cable harnesses between the Storage Controller or Interface Module and Storage Devices have been replaced by a Midplane circuit board that connects all signals and power between the Controller Module and the Storage Devices. The design of this midplane connector usually is specific to the immediate requirements of the Controller Module and Storage Devices, and a change in requirements for the Drive Enclosure will likely cause a redesign of the midplane and all Controller Modules intended to work with that midplane. For example, a midplane designed for a Fibre Channel Controller and Drives will not accommodate a SAS controller and drives due to the differences in the high speed serial channels and the type and amount of required 10 to support the different types of drives. These differences in storage technology protocols leads to reduced reuse of products and interoperability. It became evident from the above discussion that an ongoing problem persists in simplifying and reducing cost associated with distributing power and information signals between Controller Modules and Storage Devices in diverse computing and storage enterprises.

RAID (Redundant Array of Independent Disks) storage systems are well known in the art. They provide a high-speed, fault-tolerant hard disk memory. RAID systems protect against the failure of an individual disk drive by distributing the data redundantly over multiple disks. If one disk fails, the data can be recovered from the other disks. A RAID controller is used to control the input and output of a data stream on I/O line to the disks. The controller determines to which disks a given packet in the data stream will be written, and retrieves requested data from the correct disk(s). Generally, a controller microprocessor performs this function. To increase the fault tolerance of the storage subsystem, two RAID controllers are used and configured in a redundant manner. Thus, if one controller fails, the other controller can continue to store data in a non-redundant manner at essentially the same speed, or in a redundant manner at slower speed.

In prior art systems, the disk I/O system could be any of a large number of prior art communication systems, such as SCCI, SATA, SSA, ATA, FCAL, SAS, etc. I/O chips and cabling systems are determined as known in the art for the protocols for the selected system. In the prior art, the high-speed link between the controllers has been accomplished with either Gigabit Ethernet or Fibre Channel. Both types of links require a specialized chip in each controller to provide the intracontroller communication, plus appropriate wiring and connectors between the links and the controller system; hence, the high cost of the link. Gigabit Ethernet requires four high-speed differential pairs to be routed through the subsystem backplane and provides approximately 90 Mbytes/sec throughput. Fibre Channel only requires two high-speed differential pairs, and can support approximately 200 Mbytes/sec, though it is considerably more expensive than Gigabit Ethernet.

It would be a significant advance in the art if a single interconnect associated with a controller could be provided that was modular and scalable as to accommodate modules of different size and variety, while not adding significantly to the cost of the controller.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

In accordance with aspects of the present invention, a modular, scalable storage controller connector (herein referred to as a “universal controller connector”) that solves the need for modularity and scalability for use with old and new storage devices and their controllers and enabling all devices to accomplish midplane connections.

In accordance with aspects of the present invention, a modular, scalable storage controller connector that solves the need for modularity and scalability for use as midplane connections with 12, 24, 32 and 60 drive arrays by including a universal controller connector to manage signaling between the drive arrays and a controller.

In accordance with features of the invention, a connector definition enables the provision of a modular, scalable approach to storage controller connection that spans from 6 to 36+ SAS or FC drives within controller form factors.

In accordance with features of the invention, modularity of a midplane interconnect is achieved by pin layout and pin grouping into connections blocks,.wherein each module block can be added to a controller as the number of drives used in a system increases or as the interface is fiber channel versus SAS.

In accordance with another feature of the invention, a universal connector/pinout layout allowing the use of the same (universal) layout between Fibre Channel controllers, SAS controller, and 12+ drives controllers without shorting or revealing a missing pair. Accordingly, any card can be plugged into any slot comprising a universal midplane connector without experiencing shorting or missing pairs.

The ability to create a universal connector layout or connectorization layout that matches across multiple product whether the precut has a different number of drive connections or different technology.

### BRIEF DESCRIPTION OF THE DRAWINGS

The accompanying figures, in which like reference numerals refer to identical or functionally similar elements throughout the separate views and which are incorporated in and form part of the specification, further illustrate embodiments of the present invention.

FIG. 1 is a system diagram illustrating a schematic view of a hosts connecting to one or more drive boxes directly or through a bridge controller, wherein a universal controller connector supports the interconnection between the same midplane or interface module and various drives and/or hosts.

FIG. 2 illustrates the universal controller connector of FIG. 1 and its modularity through acceptance of various drive types despite the same midplane connector.

### DETAILED DESCRIPTION OF THE INVENTION

The particular values and configurations discussed in these non-limiting examples can be varied and are cited merely to illustrate embodiments of the present invention and are not intended to limit the scope thereof.

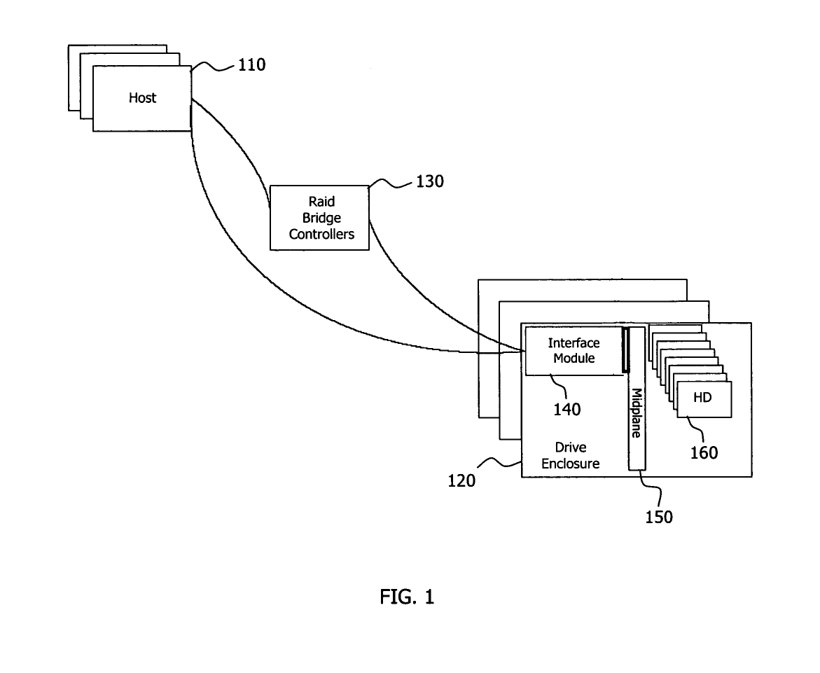

Referring to FIG. 1, from a system perspective there exists one or more hosts 110, which connects to one or more drive enclosures 120, either directly or through a bridge controller 130. External connection to the drive enclosures 120 is provided by an interface module 140. The interface module 140 connects external drive enclosure connections to a midplane 150 located inside the drive enclosure 120. The midplane 150 provides connection from the interface module 140 to drives 160. In accordance with an aspect of the present invention a universal controller connector 105 is provided between the interface module 140 and midplane 150 to connect to the interface module 140 to the midplane 150 so that connection by various system is totally internal to the drive enclosure.

The universal controller connector 105 accommodates all the necessary signaling an interface module 140 needs to ship power, 10, and discrete signaling to the drives through the midplane 150. It is a unique feature of the invention that connection within the drive enclosure 120 and signal positions along the universal controller connector 105 will be consistent across different midplane and interface module platforms. For instance, one interface module could operate with either a six drive midplane, 12 drive midplane, or 28 drive midplane. By separating the drive connections across the different connector modules, the six drive midplane, for example, could leave off the unused connectors without any change to the interface module.

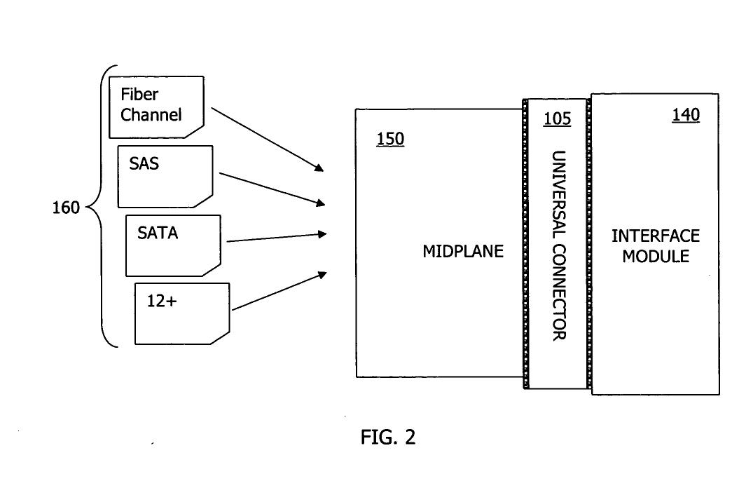

Referring to FIG. 2, another example of the modularity of the design, the signal layout covers, for example, all serial communication drive types available today 160, such as: Fiber Channel, SAS, and SATA. Therefore, for example, the midplane 150 that formerly served as a Fibre Channel midplane can be used to serve as a SATA midplane by changing the drives and the interface module 140 because of the modularity of the universal controller connector 105

We claim:

1. A connector, comprising a universal controller interface adapted to accept various driver module types and adapted to facilitate signaling between various driver module types and a single controller.

2. A modular, scalable storage controller connector for use with the communication interface between various drives and a single midplane controller, the connector comprising a midplane controller connector including a signal pin module enabling a controller to be interconnected with 12, 24, 32 and 60 drive arrays and a interface module connection.

3. A method for achieving a connector definition enabling the provision of a modular, scalable approach to storage controller midplane connections that spans from 6 to 36+ SAS or FC drives within a single controller form factors, the method comprising the step of laying out and grouping pins into universal connector module connection blocks wherein each module block can be added to a midplane controller as the number of drives used in a system increases or as the interface module becomes fiber channel versus SAS.

4. The method of claim 3 wherein the universal controller module connection blocks enable the use of a universal layout between Five Channel controllers, SAS controller, and 12+ drives controllers without shorting or revealing a missing pair.

5. The method of claim 3 wherein any card can be plugged into any slot comprising storage controller midplane connections without experiencing shorting or missing pairs.
